(19) United States
(12) Patent Application Publication
(10) Pub. No.: US 2014/0279237 A1
(43) Pub. Date: Sep. 18, 2014

(54) System and Method for Facilitating Consumer Association with Transaction Agent

(71) Applicants: John Cole, Huntsville, AL (US); Mete Kamil, Meridianville, AL (US); Ron Litzenberger, Huntsville, AL (US); Adam Campbell, Huntsville, AL (US)

(72) Inventors: John Cole, Huntsville, AL (US); Mete Kamil, Meridianville, AL (US); Ron Litzenberger, Huntsville, AL (US); Adam Campbell, Huntsville, AL (US)

(21) Appl. No.: 13/840,456

(22) Filed: Mar. 15, 2013

(51) Int. Cl. G06Q 30/06; G06Q 50/16

(52) U.S. Cl. CPC G06Q 30/0617; G06Q 50/16
USPC 705/26.43

(57) ABSTRACT

A system for facilitating association of a consumer with a transaction agent includes a database server accessible over a communications network and configured to store data comprising either of a buyer lead pool, and selling agent lead pool. The database server is accessible by an application server having a web application that allows a consumer to indicate whether the consumer is interested in buying a property or in selling property. In the former case, the system sends a message to the listing agency whereupon the listing agent may access, or “claim,” the buyer's data, and allows non-listing agents to claim the data if the listing agent declines. In case the consumer desires to sell property, the system notifies all agents within the relevant geographic area corresponding to the property and allows a consumer to interview candidate agents.

### BACKGROUND

1. Field

The system and method relates to a distributed computer-based network to facilitate consumers finding and engaging an agent.

2. Description of the Problem and Related Art

Databases for storing vast amounts of information are ubiquitous, and are created, populated, and modified constantly, typically through a network of computer-based devices. Databases typically providing information in response to a user query and compiled from data entered into the database.

One example is a web-accessible Multiple Listing Service (“MLS”) that comprises a database of real property for sale in a given geographic area and may be queried by real estate brokers, agents, buyers or sellers, to find information relating to such property. Such information includes, the type of property, whether commercial, residential, unimproved land, rental, condominium, or detached house, etc., the approximate area of the property or within any structure on the property (e.g, the approximate square footage with the living spaces of a house or condo), the number of rooms in a house, the number of bedrooms/bathrooms, the types of rooms (e.g., den, kitchen, living room, etc.), room dimensions, asking price, amenities, seller conditions, school/political district, and even photographic images of the property. Typically, an MLS listing properties for sale in a given geographic region is proprietary to a real estate professional organization, or realtor association, associated with that geographic region. For example, the MLS covering properties for sale in Charlotte, N.C., is controlled by the Charlotte Regional Realtor Association, and San Diego Association of Realtors controls the MLS for San Diego, Calif.

Prospective buyers may access the online MLS in the area in which they look to purchase property to find information regarding such property including price, area, school districts, etc. Often the MLS will also provide the listing agency or listing agent whom the buyer, or buyer's agent, should contact for a tour of the property, and more information. The interested buyer, or buyer's agent, may contact the listing agent regarding the property using telephone or email. One shortcoming of this arrangement is that there may be a considerable delay between a buyer's initial contact with the listing agent and the agent's response.

On the other side of a property transaction, prospective sellers are constantly barraged with vast amounts of promotional information about area selling agents. If a seller wishes to find an agent that will likely best represent her needs, she must sift through the information, possibly meet with several agents before finding one she would like to engage to sell her property. This arrangement requires time and coordination.

### BRIEF DESCRIPTION OF THE DRAWINGS

The system and method is described with reference to the accompanying drawings. Additionally, the left-most digit(s) of a reference number identifies the drawing in which the reference number first appears.

FIG. 1 is an illustration of an exemplary network system;

FIG. 2 is an illustration of an exemplary embodiment of a configuration of the application server and the database server indicated in FIG. 1;

FIG. 3 illustrates the application server(s) and the database server(s) of FIG. 1 in greater detail according to an embodiment in which an application is executed to facilitate association of an interested buyer with an agent;

FIG. 4 is a flow chart of an exemplary method executed by an application to facilitate association of an interested buyer with an agent according to one embodiment;

FIG. 5 is a flow chart of a second exemplary method executed by an application to facilitate association of multiple interested buyers with one or more agents according to one embodiment;

FIG. 6 is a functional illustration of an exemplary architecture according to another embodiment employing an exemplary method in which an application is executed to facilitate association of a seller with an agent;

FIG. 7 is a flow chart of a further exemplary method executed by an application to facilitate association of an interested seller with an agent;

FIG. 8A illustrates an exemplary graphic user interface for allowing a seller to communicate with one or more agents;

FIG. 8B illustrates an exemplary graphic user interface for allowing an agent to communicate with the seller of FIG. 7A;

FIG. 9 is an exemplary computer-based system.

### DETAILED DESCRIPTION

The various embodiments and their advantages are best understood by referring to FIGS. 1 through 9 of the drawings. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment of the system and method. Thus, the appearance of the phrases “in one embodiment,” “in another embodiment,” or variations thereof in various places throughout the specification are not necessarily all referring to its respective embodiment.

This system and method may be provided in other specific forms and embodiments without departing from the essential characteristics as described herein. The embodiments described above are to be considered in all aspects as illustrative only and not restrictive in any manner. The appended claims rather than the present description indicate the scope of the invention as may be construed according to applicable law.

In the following description, numerous details are set forth. It will be apparent, however, to one skilled in the art, that the system and method may be practiced without these specific details. In some instances, well-known structures and devices are shown in block diagram form, rather than in detail, in order to avoid obscuring the system and method.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “providing”, “forwarding”, “receiving”, “performing”, “comparing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The functions of the system are performed on an apparatus comprising an interconnected collection of machines configured for performing the operations disclosed herein. This apparatus may be specially constructed for the required purposes, or it may comprise one or more general purpose computer systems selectively activated or reconfigured by a computer program stored memory. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the system and method is not described with reference to any particular programming language. It will be appreciated that a variety of programming languages may be used to implement the teachings described herein.

Functions performed by the system may be provided as a computer program product, or software, that may include a machine-readable medium having stored thereon instructions, which may be used to program a computer system (or other electronic devices) to perform a process according to the system and method. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

FIGS. 1 through 3 illustrate an exemplary architecture 100 in which embodiments of the hereinafter disclosed system and method may operate. The network architecture 100 may include a computer-based application server 103 and one or more clients 110, 111 connected via a network 101, which may be a private network (e.g., a local area network (LAN), wide area network (WAN), intranet, etc.) or a public network (e.g., the internet). A computer-based database server 107 may be connected with the application server 103 and may be configured with a property listing database 305 for storing property listing data. An non-limiting example of such a listing database 305 may be a real estate multiple listing service comprising a database of real property for sale accessible by real estate brokers, agents, and in some cases, the public. Such a data listing would preferably comprise a data object, record or target which includes fields of data relevant to a piece of real property for sale, for example, as listed in the following table:

| Field | Values |
|---|---|
| Property Type 1 | Unimproved land, land plus building |
| Property Type 2 | Residential, commercial |
| Property Type 3 | Sale, Rental |
| Structure Type | Condo, Apartment, duplex, triplex, attached, detached, |
| | office, etc. |
| Area | Square Footage |
| Geolocation | Address, Geo-coordinates, etc. |
| Listing Price | Currency |
| School districts | District name or school names |
| or schools | |
| Number of | Bedrooms, bath rooms, living rooms, etc. |
| rooms | |
| Size of spaces | Room dimensions |
| Amenities | Pool, fireplace, appliances, common areas, etc. |
| Other Fields | Homeowner's Association, Property Tax Assessment, |
| | Seller Agent, multiple media (images or sounds) |
| | displaying or verbally describing the property, etc. |

It will be appreciated that other fields and values may be used in other embodiments.

Access to the network 101 is provided through a client 110, 111. Client 110, 111 may be a computing device such as, for example, a desktop computer 110b, laptop computer 110c, server, a web-enabled cellular phone 110d, personal digital assistant (PDA) 110a, etc. In one embodiment, client 110, 111 includes a browser 215 (e.g., a web browser) that enables client 110, 111 to access information maintained by, and use services provided by, application server 103. Browser 215 is an application that enables client 110, 111 to display and interact with text, images, and other information provided by servers. Browser 215 may be a web browser configured to display web pages (e.g., by using hypertext transfer protocol (HTTP), extended markup language (XML), JavaScript, etc.). In an alternative embodiment, client 110, 111 initiates service requests without use of a browser 215. An agent client 110 may be used to access the network and the application server 103 by transaction agent 131, who may be a listing agent or a selling agent, and who may be associated with an agency 130. Similarly, a consumer client 111 may be used by a consumer (buyer or seller) 132 to access the application server 103.

Application server 103 may provide one or more services (e.g., database services, systems management services, network monitoring services, transactional services, webpage viewing services, etc.) to clients 110, 111. Application server 103 may be a front end server (e.g., that provides an interface to client 110, 111) and/or a back end server. Through the application server 103, users of clients 110, 111 may request data, initiate actions, receive information, etc., via application service requests 204.

In one embodiment, application server 103 is a web application server, and is configured with a web application 309 that receives data entered from the client 110, 111 through an application service request 204. Based on the contents of the application service request 204, application server 103 may determine that web application 309 should perform one or more actions, after which application server 103 may return an application service response 206 to the client 110, 111. For example, the web application 309 provides an application response 206 comprising data structure information retrieval and display services. Application server 103 may receive an application service request 204 from client 110, 111. Though only a single web application 309 is shown, application server 103 may include multiple web applications 309 and/or other services.

Application server 103 may also be configured to respond 206 with a data entry template (described in detail below) to be displayed on the client 110, 111 in a web page. Web application 309 constructs a markup language stream, e.g., in HTML or other conventional format or protocol. That stream (or, more accurately, markup language document) is transmitted by the application server 103, per convention, to the requesting client 110, 111 for response by the user 131, 132—in this case, completion of input fields. In the illustrated embodiment, web application 309 constructs and forwards the stream to the browser 215 of client 110, 111 substantially concurrently with its request for the corresponding web page, i.e., during the same online session on which that request was made and/or within the conventional time periods expected for response to a web page, though these are not requirements of the invention. The browser 215 of client 110, 111 likewise substantially concurrently executes that stream for display to the user 131, 132 e.g., within that same online session and/or within the conventional time periods expected for execution of a web page though, again, this is not a requirement of the invention. Thus, user 131, 132 begins data entry by completing the data entry form displayed on the web page. When the template is completed, user 131, 132 executes a “submit action”. As used here, a “submit action” is a user 131, 132 action intended to signify that input fields of the data entry form are completed (or sufficiently completed) and ready for submission to the application server 103, or to other otherwise transmit an HTTP request 204 to the application server 103. These are conventional actions known in the art, such as, user selection of a “submit button” (including, user selection of a designated radio button on the web page or user selection of a designated submit button on the web page), and/or user striking of the ENTER key (or the like) on the client 110, 111. In some embodiments, if the user 131, 132 takes one of those submit actions with respect to the data entry form, the user-entered data can be transmitted to the application server 103 by way of a conventional HTTP request 204.

In one embodiment, application server 103 comprises a plurality of application servers 203a-203n. Similarly, database server 107 may comprise a plurality of database servers 207a-207n. Preferably, each application server 203i is connected to each database server 207i as depicted in FIG. 2. In yet another embodiment, the plurality of database servers 207a-207n designate a primary database server 207a with the remaining database servers 207b-207n are secondary. If data is added, or an existing data is modified or deleted, the change is made only to the primary database server 207a. The primary database server 207a then promulgates the change(s) to the secondary database servers 207b-207n. To enhance reliability of access to the database server(s) 107, the server architecture is redundantly interconnected. If the designated primary server 207a goes offline or otherwise fails, the remaining secondary servers are configured to execute control logic 922 (described below) to designate a new primary server among them. Application server 103 and database server(s) 107 may be co-located, or may be geographically remote from each other, mutually connected by a network 101. Furthermore, the plurality of application servers 203a-203n may be geographically distributed, and likewise the database servers 207a-207n may also be geographically distributed. For example, the plurality of application servers 203a-203n, and the database servers 207a-207n may be housed and maintained in a plurality of distributed data centers. It will be appreciated that this exemplary architecture enables expansion of the databases 301, 305, 307, 311 to accommodate increasing amount of data. In the illustrated embodiment, database server 107 is configured with data structure for storing and providing buyer data, such data structure being referred to herein as a database 301. Likewise, server 107 may also be configured with a database 307 comprising seller agency data for each agency 130 that lists a property for sale in the listing database 305. Data within the agency database 307 may include a sub-database 311 comprising the names and other information relating to transaction agents 131 associated with each agency 130. In addition, each seller agency may include a database of leads 313 corresponding to buyers 132 who have indicated interest in a property listed by that agency 130.

FIG. 4 illustrates an embodiment of a method executed by the web application 309 in which a listing agency may more expeditiously begin to service a prospective buyer. In this example, a buyer 132 accesses the web application 401 as discussed above and the data entry form generated by the web application 309 requests the buyer 132 to indicate whether he or she is interested 403 in a property for sale and contacting the listing agent 131 associated with the agency 130 listing the property for sale. If the buyer 132 indicates interest 405, e.g., through selecting a “radio button,” or the like, and submitting the document, the web application generates a display at 407 to determine whether the buyer 132 is already represented by a buyer agent 407. The buyer 132 is contracted to be represented by a buyer agent, the buyer agent is alerted 425 regarding the buyer's 132 interest in the property.

If the buyer 132 is not represented buyer information is requested and upon submission is entered into the buyer pool database 301, and the listing agency 130 is alerted about a new buyer lead 413 via automatic text message, automatic email message, instant messaging or other suitable means. In one embodiment, web application is configured with a timer function. Thus, preferably and substantially simultaneous with the generation of the alert to the agency 130, the timer function is executed 415 to measure the response time in which an agent 131 contacts the buyer. In another embodiment, when the seller agency is alerted at 413, the individual listing agent 131 is the only member of the agency 130 who first receives the alert. If the listing agent claims the lead 417 [how does the agent claim the lead?] the web application accesses associates the listing agent 131 with the buyer 132 in the buyer pool 313[?]. However, if the listing agent fails to claim the buyer lead within a preset time period measured by the timer, e.g., 10 minutes, the buyer information at step 419 is provided to the agency buyer lead pool 313 so that any agent 131 within the listing agency 130 may claim the lead 421 and thus become associated with that buyer 132 in step 423.

FIG. 5 depicts another version of this method executed by the web application 309 in which multiple buyers 132a, 132b, 132n, indicate interest in any property associated with the listing agency 130, virtually concurrently, using the method described with reference to FIG. 4, and the listing agency is alerted at 413. From this point, the information is provided, in this embodiment, to the agency buyer lead pool 313 at 515. Agents 131 associated with the agency 130 are alerted via text, email, instant messaging, etc., at 517. At 519, a first agent claims a buyer lead, e.g., 132A, which causes the web application 309 to initiate a timer and block agent 1 from claiming any more buyer leads 132 for a period of time, T, at 521. During this time, at step 523 another agent 131 in the agency 130 may claim a buyer lead from the agency lead pool 313. If so, the web application 309 causes a timer to initiate and block agent 2 from claiming another lead for time, T, at 525. This progression may continue until buyer lead 132N is claimed by agent N at 527. On the other hand, if no other agent claims, and there are still unclaimed buyer leads in the lead pool 313, step 529 shows that after expiry of time T the block is lifted and agent 1 may claim another buyer lead at 519. Likewise, when time T expires for agent 2, she is free to claim another buyer lead, and so on, until no more buyer leads remain in the agency buyer lead pool. In another embodiment, if only one agent is present in the agency to respond, time T may be configured to be reduced by some amount, in order to reduce the time the single agent is blocked from claiming buyer leads in order to quickly service interested consumers.

Yet another embodiment is illustrated through a functional diagram in FIG. 6. In this instance, the consumer 132 is a seller and accesses the web application 309′ using a seller client 111 in communication with an application server 103. In one embodiment, application server 103 is a web application server, and is configured with the web application 309′ that receives data entered from the client 110, 111 through an application service request 204. Based on the contents of the application service request 204, application server 103 may determine that web application 309′ should perform one or more actions, after which application server 103 may return an application service response 206 to the client 110, 111. In the illustrated example, application server 103 is also configured with a template router 601 which stores a plurality of data entry templates 603 to be displayed on the client 111 in a web page. Each data entry template 603 may be custom-defined to render the web page according to requirements for both appearance and data, and to illicit seller 132 information. In addition, templates 603 may be tailored to illicit data from the consumer that is relevant to a specific geographic region in which the property to be sold is located. Selection of the correct data entry template is conducted according any of several dimensions, or identifying characteristics, associated with the requesting consumer 132. In this regard, the template router 601 may include rules engine logic with access to a database of dimensions and corresponding data entry templates. Exemplary dimensions include site name, URL, IP address, and then resolve the directory path and file name of the proper template to be returned for rendering on the client 111 display. For example, certain geographic areas may have requirements for information a seller must provide. Data entry template may be configured to allow seller 132 to indicate whether seller desires to engage an agent, and, if so, allow seller 132 to specify desired agent background characteristics. Such agent background characteristics may include, without limitation, experience in sales of: commercial real estate; residential real estate; unimproved land; farm land; multi-unit rental properties; beach properties; mountain properties; properties exceeding a minimum sales price; urban properties; suburban properties; properties in certain neighborhoods; etc. In this regard, database server 107 may be configured with a database of all agents associated with a geographic region 611 and which includes such agents' background characteristics. When seller 132 completes the data entry template 603, he may submit the data by executing a submit action as described above.

Web application 309′ is also configured with a messaging application 605 that may be used by the seller 132 and prospective agents 131 as will be described in more detail below. Database server 107 may be configured with an agent pool database 607 that is a compilation of prospective agents 131 associated with the geographic area relevant to the seller 132 and that have indicated a desire to be engaged by the seller 132. Database server 107 may also include a message database 609 for storing messages exchanged in a messaging exchanges provided by the messaging application 605. Agents 131a, 131b, & 131b use agent clients 110a, 110b, 110n in communication over the network 101 with application server 103 to access web application 309′.

An exemplary method for facilitating a property seller engaging an agent is depicted with the flow chart of FIG. 7, beginning with 701 in which the seller 132 accesses the web application 309′. The web application 309′ is configured to request the seller indicate desire to engage an agent 703 and determines the geographic area in which the subject property is located at step 705, for example, from data submitted by the seller 132 via the data entry template 603. Subsequently, at 707, the web application 309′ accesses the area agent database 611 and causes a message alert to be issued to all agents 131 associated with the geographic area. Those agents that respond via clients 110a, 110b, & 110n, i.e., “prospective agents” 131a, 131b, & 131n, are then listed in the agent pool database 607 at step 709. Web application 309′ executes messaging application 605 to establish a messaging exchange 711 between seller 132 and a group of prospective agents 131. It may be desirable to define an upper limit on the number of prospective agents that may messaging with the seller 132 at once, e.g., no more than five agents. All other prospective agents 131 are wait-listed in the agent pool 607, preferably on a first-in/first-out basis.

At 713 and 715 renders a messaging exchange display on seller client and on agent client(s) 110, examples of which may be seen in FIGS. 8A, 8B. The seller messaging display 801 is preferably configured to display a message window 821 in which a list of messages 807, 811, managed by the messaging application 601, is displayed. The seller messaging display is configured to allow the seller to see agent messages 807a-n, from all prospective agents 805a-n, as well as seller messages 811 to the prospective agents in the messaging exchange 805. Like conventional messaging applications, the display also includes a text entry box 813. However, in this embodiment, the seller messaging display 801 preferably includes an agent selection area 815 in which prospective agents 805 in the messaging exchange are listed with a selectable icon 817, 819 in proximity to each agent 805. Web application 309′/messaging application 601, is configured to allow the seller to select the icon 819 to indicate one or more prospective agents 805 with whom the seller wishes to continue messagingting. Icon 817, 819 may be any graphic shape or symbol renderable in a mark-up language that permits execution of a submit action when selected by the user, as would be appreciated by those skilled in the relevant arts. With reference to FIG. 8B, the web application 309′/messaging application 601 is configured similarly to render a prospective agent messaging display 809; however, the agent display 809 only includes a text entry box 813 and a message window 821 that only displays messages 807x between the seller and the agent 805x.

Returning to FIG. 7, as suggested above, the web application 309′ is configured to allow seller to indicate one or more prospective agents with whom to continue messagingting at 717, and is further configured to disconnect non-selected agents at 719. At 721, if more prospective agents 131 are in the agent pool 607, the web application 309′/messaging application 601 connects another group of agents 131 with the seller 132 in the messaging exchange 723, and step 717 is performed again. If no agents remain in the pool, seller 132 may continue messagingting with agents in the messaging exchange until an agent is selected for engagement, or the seller 132 decides to quit the process.

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 900 includes a processor 902 and a main memory 904 (e.g., read-only memory (ROM), flash memory, dynamic random access memory (DRAM) such as synchronous DRAM (SDRAM) or Rambus DRAM (RDRAM), etc. Computer system 900 may also include a static memory 906 (e.g., flash memory, static random access memory (SRAM), etc.), and a secondary memory 918 (e.g., a data storage device), which communicate with each other via a communication bus 907.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute the control logic 922 for performing the operations and steps discussed herein.

The computer system 900 may further include a network interface device 908. The computer system 900 also may include a computer interface 910 comprising output device, such as a display (e.g., touch-responsive screen, a light-emitting diode (LED) display, a liquid crystal display (LCD) or a cathode ray tube (CRT)), and an input device (e.g., a keyboard, or microphone).

The secondary memory 918 may include a machine-readable storage medium (or more specifically a computer-readable storage medium) 831 on which is stored one or more sets of instructions (e.g., control logic 922) embodying any one or more of the methodologies or functions described herein. The control logic 922 may also reside, completely or at least partially, within the main memory 904 and/or within the processing device 902 during execution thereof by the computer system 900, the main memory 904 and the processing device 902 also constituting machine-readable storage media. The control logic 922 may further be transmitted or received over a network 920 via the network interface device 908.

The machine-readable storage medium 831 may also be used to store the control logic 922, databases, and/or a software library containing methods that call the control logic 922 and databases, etc. While the machine-readable storage medium 831 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the system and method. The term “machine-readable storage medium” shall accordingly be taken to include, but not be limited to, solid-state memories, and optical and magnetic media.

Control logic 922 (also called computer programs or software) is stored in the main memory and/or secondary memory. Control logic 922 can also be received via the communications interface. Such control logic, when executed, enables the computer system to perform certain features of the system and method as discussed herein. In particular, the control logic, when executed, enables a control processor to perform and/or cause the performance of features of the system and method. Accordingly, such control logic 922 represents controllers of the computer system.

The processor 902, and the processor memory, may advantageously contain control logic 922 or other substrate configuration representing data and instructions, which cause the processor to operate in a specific and predefined manner as, described hereinabove. The control logic 922 may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic 922 may be installed on the memory using a computer interface coupled to the communication bus which may be any suitable input/output device. The computer interface may also be configured to allow a user to vary the control logic, either according to pre-configured variations or customizably.

The control logic 922 conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic 922 is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein.

As described above and shown in the associated drawings, the system and method comprises a system and method for facilitating consumer association with an agent. While particular embodiments have been described, it will be understood, however, that any invention exemplified by the above disclosure is not limited thereto, since modifications may be made by those skilled in the art, particularly in light of the foregoing teachings. It is, therefore, contemplated by the appended claims to cover any such modifications that incorporate those features or those improvements that embody the spirit and scope of such invention.

What is claimed is:

1. A method using a computer-based communications network for facilitating association of a consumer with a transaction agent, said method comprising the steps of:
obtaining an indication from a consumer client device relating to whether a consumer is one of a prospective buyer and a prospective seller in connection with a property;
issuing a message regarding consumer-indicated desire to said transaction agent, said transaction agent being one of a listing agent client and a selling agent client; and
populating a database, said database being one of:
a buyer pool database comprising one or more buyer lead data relating to one or more buyers, said buyer pool database accessible by said listing agent client, said listing agent client corresponding to a listing agency associated with said property; and
an agent pool database comprising one or more prospective selling agents accessible by a consumer client.

2. The method of claim 1, further comprising a step of determining a geographic location of said property and wherein said step of issuing a message comprises accessing a database comprising one or more selling agent clients associated with said geographic location and issuing said message to said one or more selling agent clients.

3. The method of claim 2, further comprising a step of executing a messaging application on said selling agent client and said consumer client to allow a consumer to communicate with a prospective selling agent.

4. The method of claim 3, wherein said prospective selling agent is a plurality of prospective selling agents and further comprising a step of rendering a display on said consumer client, said display comprising a selectable icon configured to allow a consumer to indicate selection of a prospective agent.

5. The method of claim 1, further comprising a step of:
accessing a database comprising:
one or more said listing agencies;
the properties with which said agencies are associated; and
listing agent clients and non-listing agent clients associated with said agencies.

6. The method of claim 5, further comprising a step of:
obtaining an indication from a listing agent client that a listing agent claims one said buyer lead from said buyer pool.

7. The method of claim 6, further comprising a step of:
allowing a non-listing agent associated with said listing agency to claim a buyer lead data via a non-listing agent client.

8. The method of claim 7, further comprising the step of:
disallowing said non-listing agent from claiming more buyer lead data.

9. The method of claim 8, wherein said step of disallowing comprises disallowing said claiming for a period of time.

10. A computer-based communications network system for facilitating association of a consumer with a transaction agent, said system comprising:
a consumer client associated with said consumer, said consumer being one of a prospective buyer and a prospective seller;
an agent client associated with said transaction agent, said transaction agent being one of a listing agent and a selling agent;
a database server accessible over a communications network and configured with at least one of:
a database of properties for sale in a geographic area;
a database of listing agencies associated with said properties for sale;
a database of agents associated with said listing agencies, said agents being one of listing agents and non-listing agents;
a database of prospective buyers, comprising data corresponding to one or more buyer leads;
a database of selling agents associated with a geographic area; and
a database of prospective selling agents; and
an application server accessible over a communications network with said consumer client and said agent client, and in communication with said database server, said application server configured with control logic stored within a computer-readable medium and configured to execute a process comprising the steps of:
determining whether said consumer is a prospective buyer or a prospective seller;
determining a property of interest associated with said consumer;
issuing a message to said agent client, said message relating to said consumer; and
populating one of said database of prospective buyers, and said database of prospective selling agents.

11. The system of claim 10, wherein said step of issuing a message comprises issuing a message to agent clients associated with a listing agency corresponding to said property of interest.

12. The system of claim 11, wherein said process executed by said control logic further comprises a step of:
providing a listing agent with buyer lead data from said database of prospective buyers.

13. The system of claim 12, wherein said process executed by said control logic further comprises a step of:
providing a non-listing agent with said buyer lead data in the event said listing agent does not access said data.

14. The system of claim 10, wherein said step of issuing a message comprises issuing a message to selling agents associated with a geographic area corresponding to said property of interest.

15. The system of claim 14, wherein said control logic comprises a messaging application and wherein said process executed by said control logic further comprises a step of:
executing said message application to establish communication between said consumer client and said prospective selling agents comprising said database of prospective selling agents.

16. The system of claim 15, wherein said process executed by said control logic further comprises a step of:
rendering a display on said consumer client, display comprising a selectable icon configured to allow said consumer to indicate selection of a prospective selling agent.
